(19) United States
(12) Patent Application Publication
(10) Pub. No.: US 2022/0138691 A1
(43) Pub. Date: May 5, 2022

(54) EVENT REGISTRATION FOR BUSINESS OBJECTS

(71) Applicant: SourceCode Technology Holdings, Inc., Bellevue, WA (US)

(72) Inventors: Jonathan Dickinson, Seattle, WA (US); Mike Talley, Centennial, CO (US); Anthony Petro, Denver, CO (US); Jerry Scott Pitman, Richardson, TX (US)

(21) Appl. No.: 17/086,649

(22) Filed: Nov. 2, 2020

(51) Int. Cl. G06Q 10/10; G06Q 30/02; G06F 9/54

(52) U.S. Cl. CPC G06Q 10/103; G06Q 30/016; G06F 9/542; G06Q 30/0201

(57) ABSTRACT

Methods and systems for registering events with business objects are provided. In one embodiment, a method is provided that includes adding a new event source to a business object environment. A broker service may be created based on the new event source. The broker services may include required business object contents for receiving and processing events from the new event source. A request may be received to add the new event source. The request may specify a mapping between an event received from the new event source and performing a particular action by the business object. The broker service may be added to the business object by linking the business object to the new event source and linking events

### BACKGROUND

Computing systems may exchange information using one or more event systems. For example, upon the occurrence of a particular, specified event, the event systems may transmit a corresponding event to other computing systems. In particular, certain computing systems may subscribe to events published by other computing systems.

### SUMMARY

The present disclosure presents new and innovative systems and methods for registering events with business objects. In a first aspect, a method is provided that includes adding a new event source to a business object environment. A broker service may be created based on the new event source that includes one or more required business object contents for receiving and processing events from the new event source. A request to add the new event source to a business object of the business object environment may be received. The request specifying a mapping between an event received from the new event source and performing a particular action by the business object. The broker service may be added to the business object by linking the business object to the new event source and linking events received from the new event source to at least one action of the business object to perform the particular action.

In a second aspect according to the first aspect, the method further includes receiving and processing events from the new event source with the business object.

In a third aspect according to the second aspect, the business object is further configured to receive and process at least one of (i) events from an additional event source in addition to the new event source and (ii) data from a data source.

In a fourth aspect according to any of the first through third aspects, adding the one or more required business object contents to the business object further includes determining that at least one of the required business object contents are not included within the business object.

In a fifth aspect according to any of the first through fourth aspects, the mapping is a direct mapping between receiving an event from the event broker service and performing the particular action by the business object. The event from the event broker service may be directly linked to the at least a first subset of the required business object contents with no intervening data structures.

In a sixth aspect according to any of the first through fifth aspects, creating the broker service includes adding an inbox to the business object environment. The inbox may be subscribed to the new event source.

In a seventh aspect according to the sixth aspect, the new event source is a pull event source and the inbox is configured to periodically request events from the pull event source and, upon receiving events, to exclude duplicate events from further processing.

In an eighth aspect according to any of the sixth and seventh aspects, the new event source is a push event source that requires an authenticated callback. The inbox may be configured, in response to receiving a new event notification from the push event source, to transmit an authenticated callback to the push event source according to a communication protocol of the push event source.

In a ninth aspect according to any of the first through eighth aspects, linking the new event source includes linking the broker service to the business object.

In a tenth aspect according to any of the first through ninth aspects, the required business object contents include at least one of business object methods, business object properties, business object inboxes, and additional event sources.

In an eleventh aspect according to any of the first through tenth aspects, the method further includes storing an indication of the new event source in association with the broker service for use in adding the new event source to additional business objects.

In a twelfth aspect according to the eleventh aspect, the broker service includes the indication of the new event source.

In a thirteenth aspect according to any of the first through twelfth aspects, the method further includes, prior to adding the new event source to the business object environment, receiving a request to register the new event source.

In a fourteenth aspect according to the thirteenth aspect, the request is received from a user via a graphical user interface including a visual programming interface.

In a fifteenth aspect according to the fourteenth aspect, the broker service is configured using the visual programming interface.

In a sixteenth aspect according to any of the thirteenth through fifteenth aspects, the request includes a declarative description of the new event source.

In a seventeenth aspect, a system is provided that includes a processor and a memory storing instructions. Executing the instructions may cause the processor to add a new event source to a business object environment. A broker service may be created based on the new event source that includes one or more required business object contents for receiving and processing events from the new event source. A request to add the new event source to a business object of the business object environment may be received. The request specifying a mapping between an event received from the new event source and performing a particular action by the business object. The broker service may be added to the business object by linking the business object to the new event source and linking events received from the new event source to at least one action of the business object to perform the particular action.

In an eighteenth aspect according to the seventeenth aspect, the mapping is a direct mapping between receiving an event from the event broker service and performing the particular action by the business object, and wherein the event from the event broker service is directly linked to the at least a first subset of the required business object contents with no intervening data structures.

In a nineteenth aspect according to any of the seventeenth and eighteenth aspects, creating the broker service includes adding an inbox to the business object environment. The inbox may be subscribed to the new event source.

In a twentieth aspect a non-transitory, computer-readable medium is provided storing instructions. When executed by a processor, the instructions may cause the processor to add a new event source to a business object environment. A broker service may be created based on the new event source that includes one or more required business object contents for receiving and processing events from the new event source. A request to add the new event source to a business object of the business object environment may be received. The request specifying a mapping between an event received from the new event source and performing a particular action by the business object. The broker service may be added to the business object by linking the business object to the new event source and linking events received from the new event source to at least one action of the business object to perform the particular action.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a business object environment that uses broker services to retrieve and process data from data sources according to exemplary embodiments of the present disclosure.

FIG. 2 illustrates a business object environment that uses broker services to receive and process events from event sources according to an exemplary embodiment of the present disclosure.

FIG. 3 illustrates a detailed view of a business object and a broker service according to an exemplary embodiment of the present disclosure.

FIG. 4 illustrates a flowchart of a method for registering event sources according to exemplary embodiments of the present disclosure.

FIGS. 5A-5C illustrate flow diagrams of methods for receiving and processing events according to an exemplary embodiment of the present disclosure.

FIG. 6 illustrates a computer system according to an exemplary embodiment of the present disclosure.

### DETAILED DESCRIPTION OF EXAMPLE EMBODIMENTS

Business objects may be used by computing devices to simplify the techniques required to access and manipulate data stored in various data sources. For example, business objects such as SmartObjects by K2® may be used to interact with methods or properties of data and data sources. For example, business objects may be used to create user interfaces that non-technical users may utilize to view and manipulate data stored within the data sources.

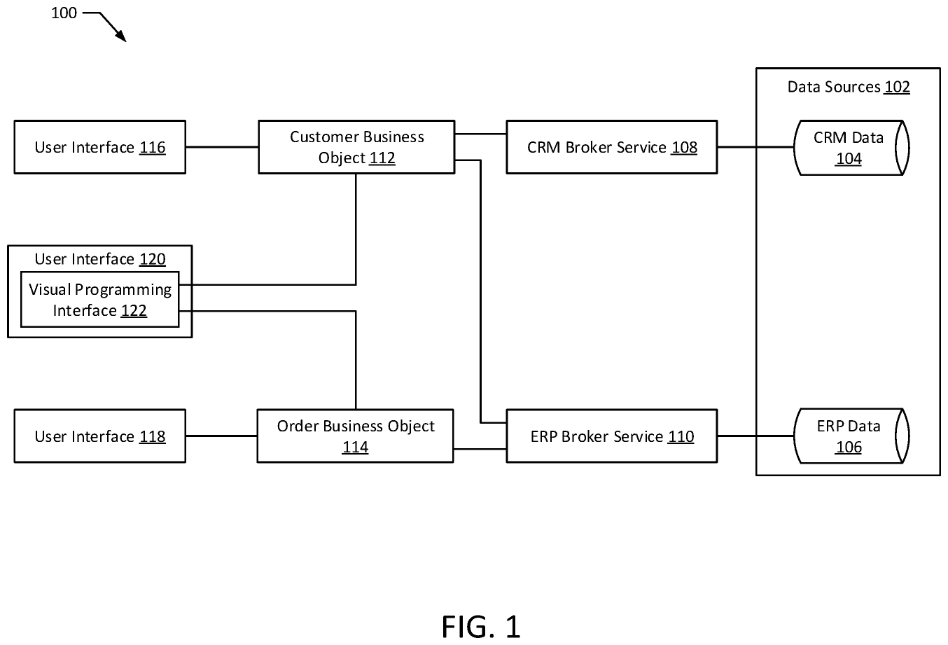

FIG. 1 illustrates a business object environment 100 that uses broker services to retrieve and process data from data sources according to exemplary embodiments of the present disclosure. The business object environment 100 includes data sources 102, which may include different types of data stored on the same data storage, different data storages, or combinations thereof. For example, as depicted, the data sources 102 include customer relationship management (CRM) data 104 and enterprise resource planning (ERP) data 106. The ERP data 106 may be received from one or more ERP applications and/or data storages and may include information regarding sales data, financial data, product manufacturing data, inventory data, product service data, customer service data, human resources data, purchasing data, materials resource planning data, and the like. The CRM data 104 may be received from one or more CRM applications and/or data storages and may include information regarding customer contacts, customer documents, marketing data, marketing outreach (e.g., sales calls, email outreach, in-person visits), and the like.

Broker services 108, 110 connect to the data sources 102. Specifically, a CRM broker service 108 connects to the CRM data 104 and an ERP broker service 110 connects to the ERP data 106. The broker services 108, 110 may be configured to expose properties and methods of the data sources 102 as standardized properties and/or methods used by business objects 112, 114 within the business object environment 100. For example, each of the data sources 102 may have different methods or properties that can be used to retrieve or manipulate data within the data sources 102 and may differ from methods or properties that can be used with business objects 112, 114. For example, methods within the data sources 102 may have a different syntax or process of calling or configuring the methods than that used by the business objects 112, 114. Accordingly, the broker services 108, 110 may be configured to translate between the syntax used by the business objects 112, 114 and the syntax used by the data sources 102. In particular, the data sources 102 may include one or more types of data storage, such as relational databases, SQL databases, NoSQL databases, network databases, object-oriented databases, hierarchical databases, and the like. Furthermore, the data sources 102 may communicate using one or more different communications protocols, such as hypertext transfer protocol (HTTP), advanced message queuing protocol (AMQP), message queuing telemetry transport (MQTT), extensible messaging and presence protocol (XMPP), and the like. In one example, the CRM data 104 may be received from a relational database that communicates using AMQP and the ERP data 106 be received from an SQL database that communicates using MQTT. In another example, enterprise content management (ECM) information and files may be received from blob storage that communicates using HTTP.

The business objects 112, 114 may then connect to one or more of the broker services 108, 110. For example, different business objects 112, 114 may correspond to different user interfaces 116, 118. For example, the business object environment 100 includes a customer business object 112 corresponding to user interface 116 and an order business object 114 corresponding to a user interface 118. Each of the user interfaces 116, 118 may correspond to a different user interface (e.g., screen, page, or other discrete user interface). Additionally or alternatively, each of the user interfaces 116, 118 may correspond to a different user interface element (e.g., form on a page, interactive field). The different user interfaces 116, 118 may correspond to different types of data (e.g., may display or manipulate different types of data). For example, the user interface 116 may be configured to display and manipulate data relating to customers and the user interface 118 may be configured to display or manipulate data relating to orders. Accordingly, the customer business object 112 corresponding to the user interface 116 may communicate with both the CRM broker service 108 and the ERP broker service 110 to access and/or manipulate the CRM data 104 and/or the ERP data 106. Continuing the previous example, the customer business object 112 may receive data from two data storages using two different types of databases (e.g., a relational database for the CRM data 104 and an SQL database for the ERP data 106) that utilize two different communication protocols (e.g., AMQP and MQTT). Also, the order business object 114 may communicate with the ERP broker service 110 to access and/or manipulate the ERP data 106. As a specific example, the ERP data 106 and the CRM data 104 may include the properties and methods indicated in Table 1 below.

TABLE 1
Exemplary Properties and Methods
for ERP Data 106 and CRM Data 104

| | ERP Data 106 | CRM Data 104 |
|---|---|---|
| Properties | OrderNumber | CustomerID |
| | OrderDate | Name |
| | OrderTime | Address |
| | CustomerID | |
| | OutstandingBalance | |
| | Total | |
| | Status | |
| Methods | CreateOrder | LoadContact |
| | LoadOrders | UpdateContact |
| | UpdateOrder | |
| | DeleteOrder | |
| | LoadBalance | |
| | UpdateBalance | |

In such instances, the customer business object 112 may combine a subset of the properties and methods for the ERP data 106 and the CRM data 104 and the order business object 114 may include a subset of the properties and methods for the ERP data 106. As a specific example, the customer business object 112 and the order business object 114 may include the properties and methods indicated in Table 2 below.

TABLE 2
Exemplary Properties and Methods
for ERP Data 106 and CRM Data 104

| | Customer Business | Order Business |
|---|---|---|
| | Object 112 | Object 114 |
| Properties | CustomerID | OrderNumber |
| | Name | CustomerID |
| | Address | |
| | OutstandingBalance | |
| Methods | LoadBalance | CreateOrder |
| | UpdateBalance | LoadOrders |
| | LoadContact | UpdateOrder |
| | UpdateContact | DeleteOrder |

The business objects 112, 114 may then be used to create, populate, and/or update the user interfaces 116, 118. For example, the user interface 116 may be used to retrieve customer information (e.g., CustomerID, Name, Address) using the LoadContact method and/or to update the customer information using the UpdateContact method. Furthermore, the user interface 116 may be used to retrieve or update the Outstanding Balance for a particular customer using the LoadBalance and UpdateBalance methods. As another example, the user interface 118 may be used to retrieve or manipulate existing orders (e.g., existing OrderNumbers) using the LoadOrders, UpdateOrder, and DeleteOrder methods. Furthermore, the user interface 118 may be used to create new orders (e.g., new OrderNumbers) using the CreateOrder method.

In this way, the business objects 112, 114 may be used to collect and present methods and properties from different data sources via the broker services 108, 110. Furthermore, the customer business objects 112, 114 and/or the user interfaces 116, 118 may be configurable by a user using one or more visual programming languages. For example, the business object environment 100 includes a user interface 120 (e.g., a graphical user interface) that includes a visual programming interface 122. The visual programming interface 122 may be used to configure the business objects 112, 114. For example, the visual programming interface 122 may be used to link the business objects 112, 114 to particular broker services 108, 110 (e.g., to particular properties and/or methods within the broker services 108, 110. Additionally or alternatively, the visual programming interface 122 may be used to configure the user interfaces 116, 118. For example, the visual programming interface 122 may be used to create a layout for any forms, pages, and the like included within the user interface 116, 118 and to identify which properties and/or methods are to be used in generating and displaying the user interfaces 116, 118.

Additional information regarding broker services and business objects for connecting to data sources is available in U.S. Pat. No. 8,239,226 and U.S. application Ser. No. 12/117,455, which are incorporated by reference.

However, as described above, business objects 112, 114 and broker services 108, 110 may typically be configured to interact with data sources, such as data storages. However, other sources of information may be useful in a business setting. For example, other information may be useful for use in generating or updating user interfaces 116, 118. As another example, other information sources may be useful in generating alerts, or in triggering the performance of other actions. In one particular example, it may be beneficial to receive and process events from various event sources. For example, events may be made available using secure publish/subscribe (e.g. “pubsub”) protocols or processes. As a specific example, events may be transmitted from various sources using the hypertext transfer protocol (HTTP) according to secure webhook pubsub procedures.

Existing systems to receive and process events may not be compatible with business object environments. In particular, as explained above, existing broker services may be configured to retrieve and store data from data sources, which may typically rely on actions from the business objects 112, 114 to trigger further processing. However, utilizing event sources may enable business objects to receive and respond to events that are broadcast. Such systems may enable faster (e.g., real-time) responses to the occurrence of events received from event sources, allowing for more responsive systems that still capitalize on the ease-of-use and interoperability of business objects. Accordingly, there exists a need to identify and make available event sources for use in business object systems.

One solution to this problem is to create event broker services that are configured to receive events from event sources. For example, the event broker services may connect to event sources (e.g., push or pull event sources) and may receive and prepare events from the event sources for further processing within business objects. As a specific example, the event broker services may transform events into properties that can be subsequently used by business objects. In certain instances, the event broker services may be linked to or added to business objects (e.g., new business objects, existing business objects) and events received by the event broker services may be used to trigger corresponding actions within the business objects. As a specific example, an event broker service may be added to a business object and events from the event broker service may be configured to trigger the execution of an action by the business object (e.g., executing a method of the business object, updating a property of the business object, performing a workflow based on the business object). In certain implementations, the event broker services may also store required business object contents, which may identify particular business object components required to receive or process events received from the event broker service.

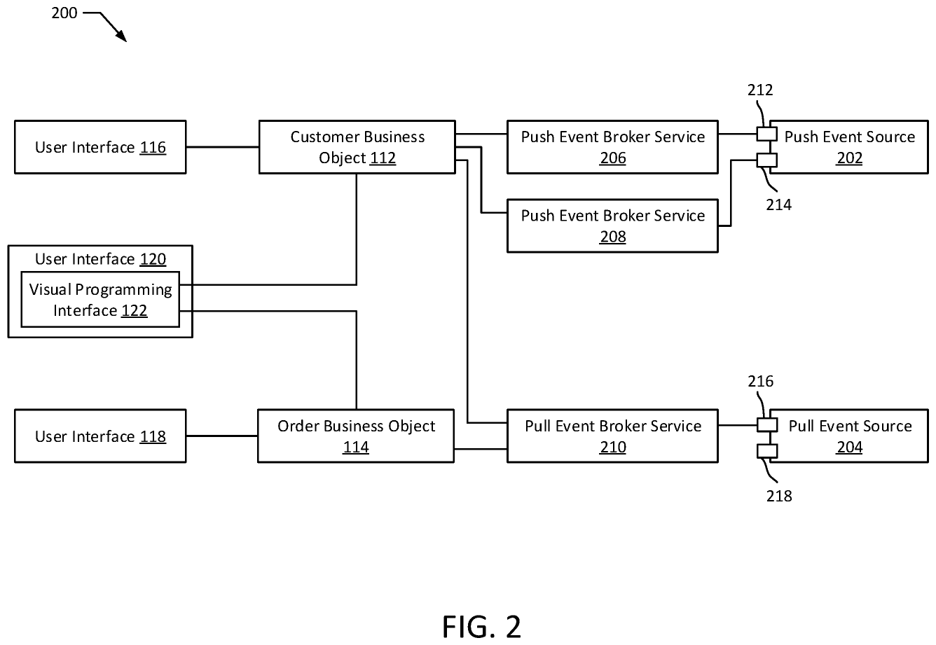

FIG. 2 illustrates a business object environment 200 that uses broker services to receive and process events from event sources according to an exemplary embodiment of the present disclosure. The business object environment 200 includes the user interfaces 116, 118, 120 and customer business objects 112, 114 discussed above in connection with the business object environment 100. The business object environment 200 further includes event sources 202, 204 and broker services 206, 208, 210. It should be understood that the business object environment 200 may be used in connection with one or more of the components discussed above in connection with the business object environment 100. For example, the business object environment 200 may, in certain implementations, include data sources 102 and broker services 108, 110. Furthermore, in certain implementations the broker services 206, 208, 210 may be implemented at least in part by the broker services 108, 110. For example, the push event broker services 206, 208 may be implemented as services executing within the CRM broker service 108 and the pull event broker service 210 may be implemented as a service executing within the ERP broker service 110. For example, the event broker services 206, 208, 210 may be implemented by the broker services 108, 110 to extend the functionality of the broker services 108, 110 to receive and process events.

The event sources 202, 204 may be servers or other computing systems configured to publish, transmit, or otherwise broadcast events upon the occurrence of particular tasks (e.g., the completion of particular tasks, the execution of particular functions, executable code, and the like). For example, the event sources 202, 204 may transmit events as one or more HTTP packets that specify the type of event and corresponding information for the particular event occurrence that triggered the transmission of the event. In certain implementations, the event sources 202, 204 may be configured to transmit events upon the occurrence of at least one of a new order being received, inventory being updated, a bill being paid by a customer, occurrence or recurrence of particular dates or times, a new data storage entry being added, a new customer relationship added (e.g., to a CRM database), a new mailing list sign up, a new employee added (e.g., to an ERP database), an employee being removed or terminated (e.g., from an ERP database), a changing employee role (e.g., in an ERP database), and the like. In light of the present discussions, one skilled in the art may recognize one or more additional events or event sources that may be used with the presently discussed techniques. All such events and event sources are accordingly considered within the scope of the present disclosure.

Event sources 202, 204 may publish events by broadcasting the events as the corresponding tasks occur. For example, the push event source 202 may be communicatively coupled to a CRM system. A new customer may be added to the CRM data storage and the push event source 202 or a process within the CRM system may detect that the new customer is added. In response, the push event source 202 may create the event (e.g., as an HTTP packet) identifying one or more of the CRM system, the new customer (e.g., name, contact information), and a time at which the new customer was added. The push event source 202 may then “push” the event by publishing or transmitting the event to one or more subscribed computing devices, which may include one or more of the computing devices implementing the push event broker service 206 and/or the push event broker service 208. As a specific example, the event broker services 206, 208 may utilize one or more inboxes to receive events from the event sources 202, 204. For example, the inboxes may be implemented within and/or separate from the event broker services within the business object environment 200. In certain implementations, events transmitted by the push event source 202 may contain a payload (e.g., may contain data regarding an occurrence that caused the event to be created and transmitted). In additional or alternative implementations, events transmitted by the push event source 202 may not contain a payload. In such instances, the event may instead contain an event identifier (e.g., an alphanumeric identifier). In response to receiving the event, the push event broker service 206, 208 may execute a method to query the push event source 202 and/or a corresponding data source 102 with the event identifier (e.g., using an authenticated callback) and, in response to the query, may receive data describing the occurrence that caused the event to be created and transmitted.

Additionally or alternatively, event sources 202, 204 may store new events and users may pull data corresponding to the new events as needed or requested. For example, the pull event source 204 may be communicatively coupled to an ERP system. A new order may be added to an order data storage of the ERP system and the pull event source 204 or a process within the ERP system may detect that the new order has been added. In response, the pull event source 204 may create an event (e.g., as an HTTP packet) that identifies the ERP system, the order added to the order data storage (e.g., an order identifier), a time at which the order was added to the order data storage, order information (e.g., products purchased, quantity purchased), and the like. The pull event source 204 may store the event for retrieval by other computing devices. The pull event source 204 may receive a request from a subscribed computing device (e.g., a computing device implementing the pull event broker service 210) and may provide the new event and any other new events to the subscribed computing device. In certain instances, the pull event source 204 may only provide events to subscribed computing devices that the subscribed computing devices have not yet received. For example, the pull event source 204 may store IP addresses or other computing device identifiers in association with particular events (e.g., the most recent event that a corresponding computing device has received). Additionally or alternatively, the pull event source 204 may receive an indication of the most recent event received and may transmit all subsequent events. Additionally or alternatively, the pull event source 204 may require periodic querying and processing for changes in data, aka ‘polling’, to mimic an event received from a push event source.

Event sources 202, 204 may have different endpoints 212, 214, 216, 218, which may correspond to different types of events. For example, the push event source 202 has two endpoints 212, 214, which may correspond to different types of events. As a specific example, the endpoints 212 may correspond to events created when a new customer is added to a CRM data storage and the endpoint 214 may correspond to events created when a new employee is added to the CRM data storage. The event sources 202, 204 may be accessible at particular addresses. For example, the event sources 202, 204 may be accessible using universal resource locators (e.g., URLs) containing particular host names or domain names. Additionally or alternatively, the event sources 202, 204 may correspond to a particular path or subdomain within a particular hostname or domain name. Where the event sources 202, 204 are accessible at particular addresses, the endpoints 212, 214, 216, 218 may correspond to certain portions of the event sources. For example, the endpoints 212, 214, 216, 218 may be accessible using a URL containing a particular subdomain, a particular path, or particular parameters (e.g., application programming interface (API) parameters).

The broker services 206, 208, 210 may connect to the event sources 202, 204 and may translate events from the event sources 202, 204 into properties and/or methods usable by business objects 112, 114 within the business object environments 200. For example, the broker services 206, 208, 210 may be configured to extract information from HTTP packets corresponding to events and may transform the extracted information into properties or methods. In certain implementations, the transformations performed by the event broker services 206, 208, 210 may be predetermined. For example, event broker services 206, 208, 210 may be created, configured, and/or updated using a visual programming interface such as the visual programming interface 122. In such instances, the translations performed by the event broker services 206, 208, 210 may be specified in a request received from the visual programming interface 122. The event broker services 206, 208, 210 may also specify particular components required for business objects 112, 114 that connect to the event broker services 206, 208, 210. For example, the event broker services 206, 208, 210 may specify one or more required business object contents necessary to receive, process, and/or manipulate events received from a corresponding endpoint 212, 214, 216 of an event source 202, 204. As explained further below, the required business object contents may include, e.g., methods, properties, inboxes, and/or other event broker services.

Business objects 112, 114 may typically be configured to connect to different broker services for different sources of information, as discussed above in connection with the business object environment 100. Accordingly, business objects 112, 114 may connect to multiple event broker services 206, 208, 210 associated with different endpoints 212, 214, 216 of the event sources 202, 204. For example, the customer business object 112 is connected to (i.e., has “added”) the push event broker service 206 corresponding to the endpoint 212 of the push event source 202, the push event broker service 208 corresponding to the endpoint 214 of the push event source 202, and the pull event broker service 210 corresponding to the endpoint 216 of the pull event source 204.

Different types of event broker services 206, 208, 210 may be used for different types of event sources 202, 204. For example, push event broker services 206, 208, when added to the business object environment 200, may subscribe to receive events from corresponding endpoints 212, 214 of the push event source 202 on a push basis (e.g., as the events occur and are transmitted). As another example, pull event broker services 210, when added to the business object environment 200, may subscribe to receive events from corresponding endpoints 216 of the pull event source 204 on a pull basis (e.g., as events are requested). The pull event broker service 210 may be configured to further track which events have already been received from the pull event source 204. When requesting new events, the pull event broker service 210 may provide information regarding already-received events (e.g., the most-recently received event) to the pull event source 204. Additionally or alternatively, the pull event broker service 210 may compare events received from the pull event source 204 to events that have been already received and may remove duplicate events received from the pull event source 204. In certain implementations, push event broker services 206, 208 may similarly compare events received from push event sources 202 to previously-received events to remove duplicate events received from the push event source.

The business object environment 200 may receive a request to add an event source 202, 204. For example, the business object environment 200 may receive a request from the visual programming interface 122 or another, code-based programming interface. The request may include an identifier of the event source 202, 204 to be added (e.g., a URL corresponding to the event source 202, 204 and/or one or more endpoints 212, 214, 216, 218 of the event source 202, 204). The event source 202, 204 may then be added to the business object environment 200 by storing an indicator of the event source 202, 204 and/or the endpoints 212, 214, 216, 218 identified in the request.

Event sources 202, 204 and endpoints 212, 214, 216, 218 may then be utilized to create event broker services 206, 208, 210. For example, the business object environment 200 may receive a request (e.g., from a visual programming interface 122) to create a new event broker service 206, 208, 210. The request may specify a corresponding event source 202, 204 or endpoint 212, 214, 216, 218 for the event broker service 206, 208, 210 and may specify one or more properties and/or methods made available by the event broker service 206, 208, 210 (e.g., based on events received from the event source 202, 204 or endpoints 212, 214, 216, 218). The request may also specify information received within events from the event source 202, 204 or endpoint 212, 214, 216, 218. For example, the request may specify a format for data stored within the events. The request may further include a mapping (e.g., a JSON mapping) between information stored within the events and the methods or properties made available by the event broker service 206, 208, 210 to be created. For example, a request may be received to create an event broker service to connect to the endpoint 214 of the push event source 202. Events received from the endpoint 214 may contain order information stored in a JSON format. As a specific example, the events may contain a JSON file storing information as:

```
“orders”: [
  {
    “orderno”: “1234567890”,
    “date”: “July 7, 2020 3:58:3 PM”,
    “custid”: “12345”,
    “total”: “$3,456”
  }
]
```

In such instances, the request to create the event broker service 206, 208, 210 may specify a mapping between the fields of the JSON file and one or more properties for use by business objects 112, 114 within the business object environment 200. For example, the mapping may include a corresponding property for the fields of the JSON file and may include corresponding transformations for one or more of the fields. As a specific example, the request may include a mapping as specified in Table 3 below.

TABLE 3
Exemplary Mapping Between Event Data and Properties

| JSON Field | Property | Transformation |
|---|---|---|
| “orderno” | OrderNumber | None |
| “date” | OrderDate | Extract and convert |
| | | to MM/DD/YYYY format |
| | OrderTime | Extract and convert |
| | | to 24 hour format |
| “custid” | CustomerID | None |
| “total” | Total | Convert to currency format |

An event broker service 206, 208, 210 may be added to the business object environment 200 by connecting the event broker service 206, 208, 210 to the event source 202, 204 or endpoint 212, 214, 216, 218 specified within the request and by implementing the mapping and/or transformations specified within the request. The event broker service 206, 208, 210 may be subsequently added to one or more business objects 112, 114 within the business object environment 200.

In the above examples, business objects 112, 114 and event broker services 206, 208, 210 were described as being created or configured using a visual programming interface 122. It should be appreciated that, in additional or alternative implementations, the business objects 112, 114 and/or event broker services 206, 208, 210 may also be created or configured using a more conventional, code-based (or text-based) programming interface. For example, sample code is provided below that may be used to create a business object and to describe the available methods, events, and inboxes used by the business object. Line numbers have been added to the sample code below for easier reference.

```
public override string DescribeSchema( )
{
  (1) var customer = Service.ServiceObjects.Create(“customer”);
  (2) customer.MetaData = new MetaData(“Customer”, “The customer
    business object.”);
  (3) var idProperty = customer.Properties.Create(“id”);
  (4) idProperty.SoType = SoType.Autonumber;
  (5) idProperty.MetaData = new MetaData(“ID”, “The customer identifier.”);
  (6) var nameProperty = customer.Properties.Create(“name”);
  (7) nameProperty.SoType = SoType.Text;
  (8) nameProperty.MetaData = new MetaData(“Name”, “The customer
    name.”);
  (9) var listMethod = customer.Methods.Create(“getlist”);
  (10) listMethod.Type = MethodType.List;
  (11) listMethod.ReturnProperties.Add(idProperty);
  (12) listMethod.ReturnProperties.Add(nameProperty);
  (13) var createdEvent = customer.Events.Create(“created”);
  (14) createdEvent.MetaData = new MetaData(“Customer Created”, “A
    customer was created.”);
  (15) createdEvent.EventProperties.Add(idProperty);
  (16) var allEventsInbox = customer.Inboxes.Create(“allEvents”);
  (17) allEventsInbox.MetaData = new MetaData(“All Events”, “Receives all
    events from the ERP system.”);
  (18) return base.DescribeSchema( );
}
```

In the sample code above, lines (1)-(2) may be performed to create a customer business object 112. Lines (3)-(8) may be performed to identify and describe the properties available for the customer business object 112 (e.g., properties that can be viewed or manipulated using the customer business object 112). Lines (9)-(12) may be performed to identify and describe the methods available with the customer business object 112 (e.g., predefined methods for use by customer business objects). Lines (13)-(15) may be performed to identify and describe the events used by the customer business object 112. Lines (16)-(17) may be performed to describe the inboxes required by the customer business object 112 (e.g., inboxes required to receive the events used by the customer business object 112. Line (18) may be performed to return the schema describing the above items used by the customer business object 112.

The business object environments 100, 200 and their constituent components may be implemented by one or more computing systems. For example, one or more of the data sources 102, the broker services 108, 110, the business objects 112, 114, the user interfaces 116, 118, 120, the event sources 202, 204, and the event broker services 206, 208, 210 may be implemented by one or more computing systems. For example, although not depicted, one or more of the data sources 102, the broker services 108, 110, the business objects 112, 114, the user interfaces 116, 118, 120, the event sources 202, 204, and the event broker services 206, 208, 210 may contain a processor and a memory that implements at least one operational feature. As another example, the memory may contain instructions which, when executed by the processor, cause the processor to implement at least one operational feature.

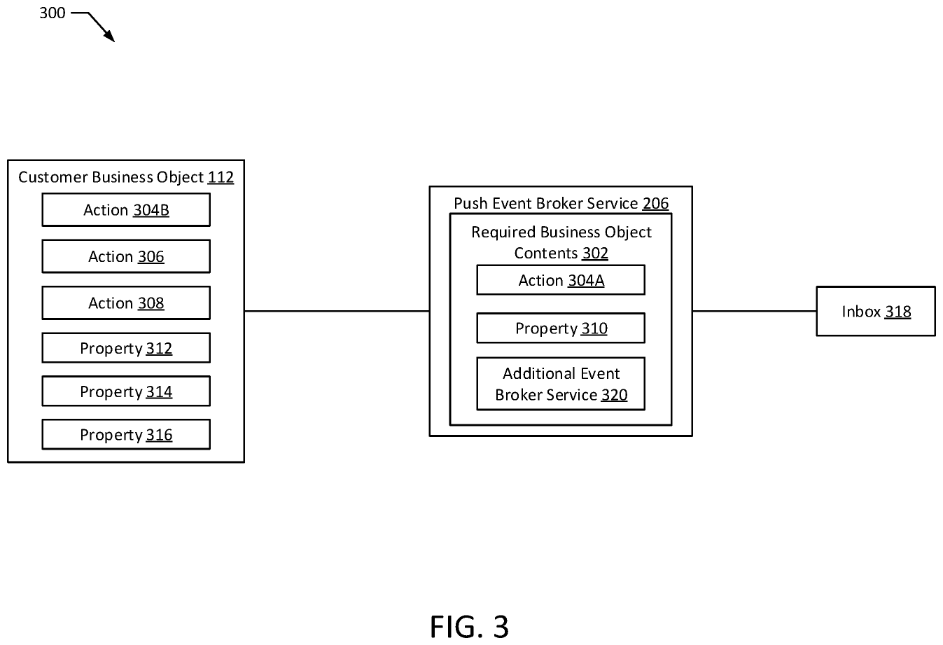

FIG. 3 illustrates a detailed view 300 of the business object 112 and the broker service 206 according to an exemplary embodiment of the present disclosure. The detailed view 300 includes the customer business object 112, the push event broker service 206, and an inbox 318. The push event broker service 206 includes required business object contents 302, which may specify one or more required aspects for a business object linked to the push event broker service 206. As depicted, the required business object contents 302 include an action 304A, a property 310, and an additional event broker service 320. In certain implementations, the required business object contents 302 may include more than one object of the same type. For example, the required business object contents may include two or more actions 304A, two or more properties 310, and/or two or more additional event broker services 320. The customer business object 112 includes actions 304B, 306, 308 and properties 312, 314, 316. In certain implementations, the action 304B may be a copy of the action 304A (e.g., may be identical to the action 304A). Because the customer business object 112 includes actions 304B, 206, 208 that can be executed in response to received events in addition to other data sources (e.g., properties 312, 314, 316 from one or more other data sources), the customer business object 112 may be considered a composite business object. For example, in certain implementations, the customer business object 112 as depicted in FIG. 3 may be implemented as a composite SmartObject from K2®.

Actions 304A, 304B, 306, 308 may be configured to perform one or more functions when executed (e.g., when executed by a business object 112). For example, the action 304A associated with the push event broker service 206 may be configured to perform a function relating to events received from a push event source 202 corresponding to the push event broker service 206. As a specific example, the action 304A may include executing a method of a business object 112, 114. As a further example, the action 304A may be performed by the business object 112, 114 to send an email based on a received event (e.g., based on information contained within the received event). As another example, the action 306 associated with the customer business object 112 may be configured to perform a function relating to the customer business object 112. As a specific example, the action 306 may be performed to update contact information in a CRM data storage (e.g., by performing an “UpdateContact” method). The action 304A may include one or more operations (e.g., one or more operations written in an executable program code) that are executed to perform a desired function.

Properties 310, 312, 314, 316 may specify one or more stored data objects associated with particular components of the business object environment 200. For example, a property 310 associated with the push event broker service 206 may store data regarding a received event (e.g., as explained above in exemplary Table 3). As another example, a property 312, 314, 316 associated with a business object 112 may store data regarding the business objects 112 and/or a broker service to which the business object 112 is linked (e.g., as explained above in exemplary Table 2). Properties 312, 314, 316 associated with business objects 112 may include data objects regarding one or more broker services 108, 110, one or more data sources, and/or one or more event broker services 206, 208, 210. In certain instances, properties 310, 312, 314, 316 may be reflected in received data and/or received events. Additionally or alternatively, properties 310, 312, 314, 316 may reflect the results of one or more methods 304A, 304B, 306, 308 performed by a business object 112. In particular, business objects may include properties corresponding to multiple types of data sources (e.g., two different types of data, three different types of data). For example, a business object may include properties 310 associated with one or more event sources, properties 312, 314 associated with a data source 102, and properties 316 associated with data received directly from a user. Relatedly, a business object may have properties 310 associated with different types of event sources, properties 312, 314 associated with different data source 102, and/or properties 316 associated with different data received from a user. In one specific example, a business object may receive data from (and therefore have properties associated with) three or more different types of data sources (which may use different types of communication protocols), such as a relational database utilizing an AMQP protocol, an SQL database utilizing an MQTT protocol, and a push event source (e.g., a push event source with authenticated callbacks) that utilizes an HTTP protocol.

The inbox 318 may be configured to receive events from the event source 202 for further processing by the event broker service 206. For example, the inbox 318 may be configured to receive new events from the push event broker service as they are transmitted from the push event source 202. In additional or alternative implementations, and as explained further below, the inbox 318 may be configured to communicate with the push event source 202 (e.g., to provide an authenticated callback before receiving the payload). In further implementations (e.g., for inboxes communicating with pull event sources 204, the inbox 318 may be configured to request new events. As depicted, the inbox 318 executes separately from (e.g., as a separate software process from) the push event broker service 306. It should be understood that, in additional or alternative implementations, the inbox 318 may execute within the push event broker service 206.

The required business object contents 302 may also specify the format of events received from the event broker service 206 (e.g., one or more properties containing data and/or data formats within the events or properties received from the event broker service). As a specific example, the inbox 318 may specify the format for times received from the event broker service (e.g., AM/PM format, 24-hour format, UTC format), dates received from the event broker service (e.g., MM/DD/YYYY, DD/MM/YYYY, DDMMYY, UTC format), numerical values (e.g., integers, floats), and the like. In additional or alternative implementations, the push event broker service 206 may be configured to transform data within received events. In such instances, the required business object contents may specify the format of data and/or events provided by the push event broker service 206.

Certain events received from the event broker service 206 or certain actions 304A specified by the event broker service 206 may require events that are received from other event broker services 208, 210. For example, events received from the push event broker service 206 may include order information, such as order identifiers and customer identifiers for newly-received orders, and events received from the push event broker service 208 may include sales information, such as product information and quantity information corresponding to particular order identifiers. Events from both push event broker services 206, 208 may be required to perform particular actions 304A associated with the push event broker service 206 (e.g., actions 304A performed to collect customer, product, and quantity information for newly-received orders). In such instances, the additional event broker service 320 may identify the push event broker service 208 as also being required. The additional event broker service 320 may identify the additionally-required event broker service 208 according to a name (e.g., a service name) and/or an address (e.g., an address within the business object environment 200, an IP address).

The business object environment 200 may receive a request to add an event broker service 206 to a business object 112. Upon receiving the request, the business object environment 200 may compare the required business object contents 302 to the contents of the business object 112 (e.g., the actions 304B, 306, 308 and properties 312, 314, 316). Any of the required business object contents 302 that are not included within the business object 112 may be added to the business object 112. For example, the actions 304B, 306, 308 already contained within the business object 112 may be compared to the action 304A within the required business object contents 302. As explained above, the action 304B may be identical to the action 304A. Accordingly, it may be determined that the action 304A is already included within the business object 112 and does not need to be added. As another example, the properties 312, 314, 316 already contained within the customer business object 112 may be compared to the property 310 contained within the required business object contents 302. It may be determined that the business object 112 does not contain the property 310, and the property 310 may accordingly be added to the business object 112. Additionally, the push event broker service 206 may be linked (e.g., communicatively coupled) to the business object 112 so that the business object 112 may receive events from the broker service 206.

It should be understood that similar processes may be performed when connecting other broker services to other business objects. For example, the business object environment 200 may perform similar processes when linking the event broker services 208, 210 to the customer business object 112 and when linking the event broker service 210 to the order business object 114.

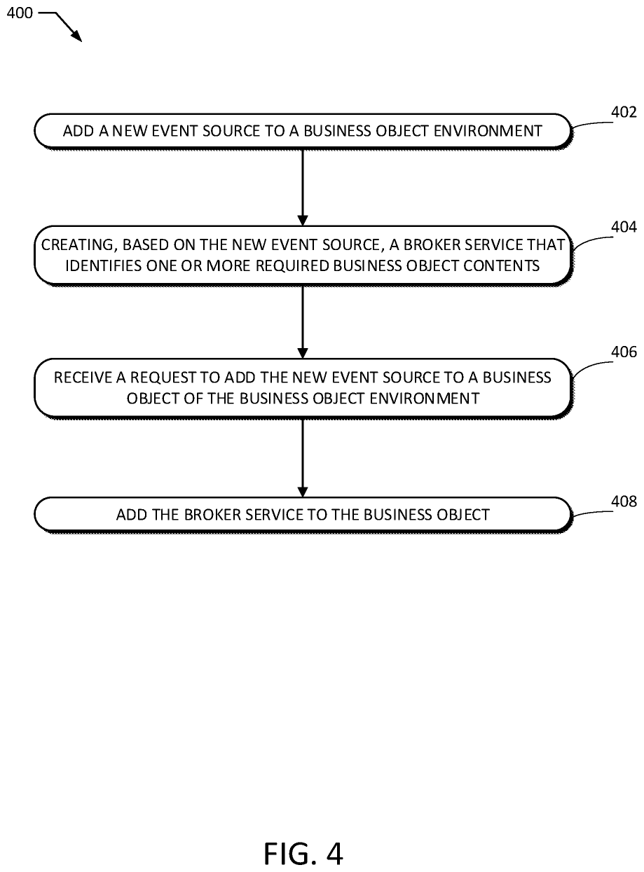

FIG. 4 illustrates a flowchart of a method 400 for registering event sources according to exemplary embodiments of the present disclosure. The method 400 may be implemented on a computer system, such as the business object environment 200. For example, the method 400 may be implemented at least in part by one or more business objects 114, a visual programming interface 122, one or more event broker services 206, 208, 210, and/or one or more event sources 202, 204. The method 400 may also be implemented by a set of instructions stored on a computer-readable medium that, when executed by a processor, cause the computer system to perform the method 400. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks described may be optional.

The method 400 may begin with adding a new event source to a business object environment (block 402). For example, a new event source 202, 204 may be added to a business object environment 200. The event source 202, 204 may be a push event source 202 and/or a pull event source 204. As explained above, the event source 202, 204 may be added in response to a request received by the business object environment 200. In certain instances, the new event source may include a new endpoint 212, 214, 216, 218 for an existing event source 202, 204 within the business object environment 200. For example, a request may be received from a visual programming interface 122 that identifies the new endpoint 212, 214, 216, 218 to be added. Additionally or alternatively, adding the new event source 202, 204 to the business object environment 200 may include detecting one or more endpoints 212, 214, 216, 218 (e.g., querying the new event source 202, 204 for endpoints 212, 214, 216, 218) and adding the endpoints 212, 214, 216, 218 of the new event source 202, 204 to the business object environment.

A broker service may be created based on the new event source (block 404). For example, an event broker service 206, 208, 210 may be created based on the new event source 202, 204. The event broker service 206, 208, 210 may identify one or more required business object contents 302. For example, as explained above, accessing the event broker service 206, 208, 210 may require one or more actions 304A, properties 310, inboxes 318, and/or additional event broker services 320. The required business object contents 302 may identify any such components required to access the event broker service 206, 208, 210 and/or to process events received from the event broker service 206, 208, 210. The event broker service may also specify one or more transformations applied to events received from the new event source 202, 204. For example, the event broker service 206, 208, 210 may specify one or more transformations between data contained within received events and properties 310 associated with the event broker service 206, 208, 210. Similar to the new event source 202, 204, the event broker service 206, 208, 210 may be created in response to a request received by the business object environment 200. For example, a request may be received from the visual programming interface 122 identifying the required business object contents and/or any transformations applied to events received from the new event source 202, 204. In certain instances, after the event broker service is created, an indication of the event broker service may be stored in association with the event source 202, 204 (e.g., in a data storage of the business object environment 200), which may be used to add the event broker service to additional event sources (e.g., after completion of the method 400).

A request may be received to add the new event source to a business object of the business object environment (block 406). For example, a request may be received to add the new event source 202, 204 to a business object 112, 114 within the business object environment 200. For example, the request may be received from a visual programming interface 122 of the business object environment 200. The request may identify the event broker service 206, 208, 210 created at block 404 to add the new event source 202, 204 to the business object 112, 114.

The broker service may be added to the business object (block 408). For example, the event broker service 206, 208, 210 may be added to the business object 112, 114. In particular, adding the event broker service 206, 208, 210 may include linking the business object 112, 114 to the event broker service 206, 208, 210 such that new events (or new events of a particular type) received by the event broker service 206, 208, 210 are provided to the business object. As explained above, adding an event broker service 206, 208, 210 to a business object 112, 114 may include comparing one or more of the required business object contents 302 to the contents of the business object 112. In particular, as explained above, the actions 304B, 306, 308 and properties 312, 314, 316 of the business object 112, 114 may be compared to actions 304A and properties 310 within the required business object contents 302. Any actions 304A and/or properties 310 that are not included within the business object 112, 114 may be added to the business object 112, 114 (e.g., by copying the actions 304A and/or properties 310 to the business object 112, 114). Additionally or alternatively, where the required business object contents 302 specify an additional event broker service 320, the additional event broker service 320 may be added, as required, to the business object 112.

In certain implementations, the request to add the new event source to the business object 112, 114 may include a mapping between an event received from the new event source 202, 204 (e.g., received by the event broker service 206, 208, 210) and a particular action to be performed. For example, the particular action may be specified as a specific action 304A, 304B, 306, 308 within the business object 112, 114 (e.g., a method of the business object 112, 114). As a specific example, where the event broker service 206, 208, 210 receives events regarding new orders, the particular action may include an action to generate and send an order confirmation email to a customer associated with a new order. In such instances, to add the event broker service 206, 208, 210 to the business object 112, 114, events received by the event broker service may be linked with an action 304A, 304B, 306, 308 that includes instructions to create and send an order confirmation email. As a particular example, one or more properties 310 of received events may be linked (e.g., via the action) to particular fields within the order confirmation email, such as an email address, the subject line, and/or portions of the contents of the email. As another example, the action performed in response to receiving an event from the event broker service 206, 208, 210 may include updating one or more properties 310, 312, 314, 316 of the business object 112, 114 and/or corresponding properties of a data storage or other data source.

The method 400 may enable event sources to be added to business object environments and to allow for processing of the events received from the event sources into formats (e.g., properties and methods) that can be utilized by business objects. Additionally, the method 400 may enable event broker services that receive and process the events to be added to business objects, allowing for event-based functionality (e.g., actions triggered by events) to be added to existing business objects and user interfaces without requiring further setup or configuration.

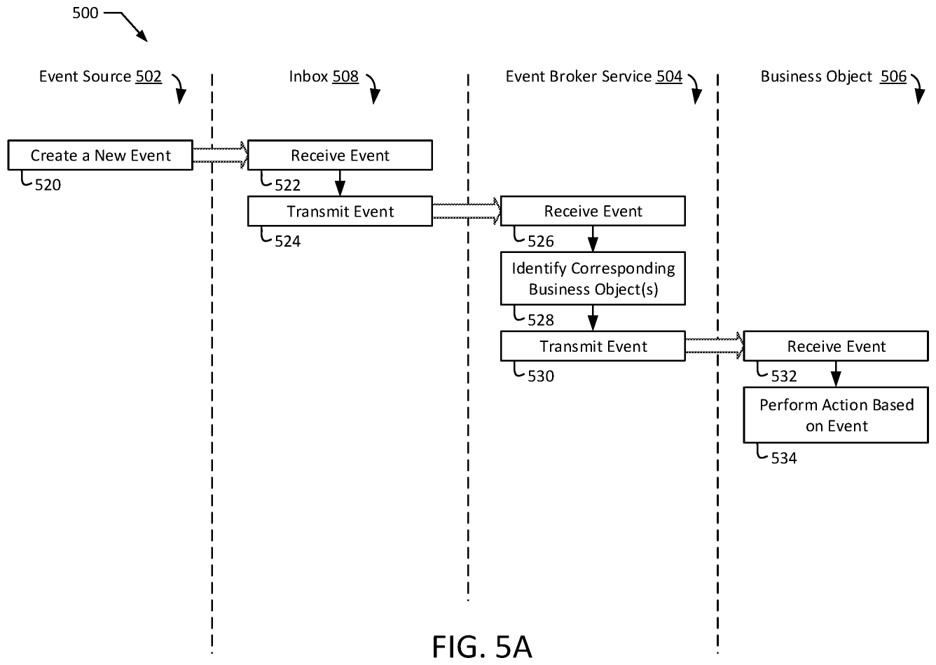

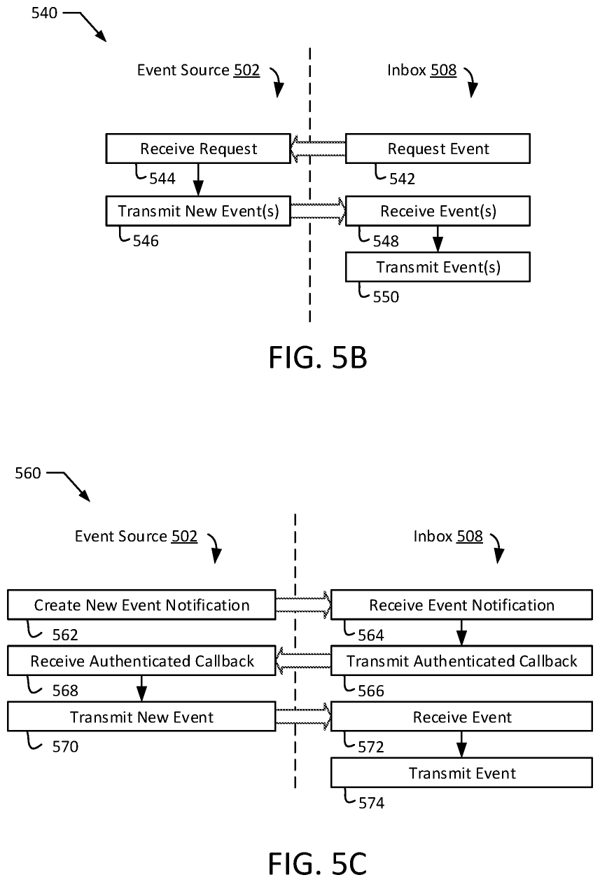

FIGS. 5A-5C illustrate flow diagrams of methods 500, 540, 560 and for receiving and processing events according to an exemplary embodiment of the present disclosure. The methods 500, 540, 560 may be implemented on a computer system, such as the business object environment 200. For example, FIG. 5A includes an event source 502, which may be an exemplary implementation of the event sources 202, 204, an event broker service 504, which may be an exemplary implementation of the event broker services 206, 208, 210, an inbox 508, and a business object 506, which may be an exemplary implementation of the business objects 112, 114. In certain implementations, the inbox 508 may be implemented as part of the event broker service 504 (e.g., as a software service executing within the event broker service 504. In additional or alternative implementations, the inbox 508 may execute as an external software service separate from the event broker service 504. The method 500, 540, 560 may also be implemented by a set of instructions stored on a computer-readable medium that, when executed by a processor, cause the computer system to perform the method 500, 540, 560. Although the examples below are described with reference to the flowchart illustrated in FIGS. 5A-5C, many other methods of performing the acts associated with FIGS. 5A-5C may be used. For example, the order of some of the blocks may be changed, certain blocks may be combined with other blocks, one or more of the blocks may be repeated, and some of the blocks described may be optional.

The method 500 begins with the event source 502 creating a new event (block 520). The event source 502 may create the new event in response to the occurrence of a particular task or event or recurrence of time. For example, the event source 502 may be associated with a computing service (e.g., a CRM system, an ERP system) and may create an event whenever particular events occur or tasks are completed within the associated computing service. As a specific example, the event source 502 may create an event each time a new sign-up is received for an email list (e.g., an email list associated with a retailer or commerce platform). Upon creating the event, the event source 502 may transmit the event to subscribed computing devices (e.g., inboxes that subscribed). For example, the event source 502 may be a push event source and the event broker service 504 and/or inbox 508 may be subscribed to the event source 502. In such instances, the event broker service 502 may transmit the new event to the event broker service.

The inbox 508 may then receive the event from the event source 502 (block 522) and may transmit or otherwise provide the event to the event broker service 504 (block 524). As depicted, the inbox 508 receives the event from the event source 502 as a single transmission (e.g., as a push event received from a push event source in a single transmission). As explained further below in connection with the methods 540, 560, in certain instances, additional transmissions to and/or from the event source 502 may be required to completely receive a new event (e.g., to receive a payload associated with the new event). The event may be transmitted to the event broker service 504 by making the event available to the event broker service 504 (e.g., when the inbox 508 executes within the event broker service 504) and/or by transmitting a copy of the event to the event broker service 504 (e.g., when the inbox 508 executes separate from the event broker service 504).

The event broker service 504 may then receive the event from the inbox 508 (block 526). Upon receiving the event, the event broker service 504 may transform the received event into particular properties (e.g., properties 310 associated with the event broker service 504), as explained above. For example, the event broker service may transform the received event according to one or more of the translations and translation strategies described in U.S. application Ser. No. ______ (Attorney Docket No. 3714669.00149), filed ______ and titled “EVENT TRANSLATION FOR BUSINESS OBJECTS.” The event broker service 504 may then identify one or more corresponding business objects 506 for the event (block 528). For example, when an action or other dependency within a business object 506 is linked to events from the event broker service 504, the event broker service 504 may receive an identifier (e.g., a name, a numerical identifier, a unique identifier, a network address) of the business object 506 and/or a type of event that the business object 506 is to receive. To identify corresponding business objects 506 for received events, the event broker service 504 may determine a type of event (e.g., a type based on the event source 502, a type based on the inbox 508 that received the event, a type indicated within metadata of the event) and may identify business objects 506 associated with the type of event. The event broker service 504 may then transmit the event to the corresponding business object(s) 506 (block 530). The event may be transmitted to the business object 506 by transmitting the properties to the business object 506 and/or by making the properties available (e.g., within an intermediate data storage or other data store) and by transmitting an indication of the newly-available event to the business object 506.

The business object 506 may receive the event (block 532). For example, the business object 506 may receive properties transmitted by the event broker service 504 and/or may receive an indication of a new event from the event broker service 504 and may retrieve the properties from the event broker service 504. The business object 506 may then perform an action based on the event (block 534). For example, one or more actions (e.g., functions, methods, workflows) may be linked to different types of events within the business object 506 and/or to events received from the event broker service 504. Upon receiving the event from the event broker service, the inbox 508 and/or the business object 506 may identify a corresponding action for the event and may perform the action. For example, when the event broker service 504 is added (or otherwise linked) to the business object 506, the request to add the event broker service 504 may specify a corresponding action for events received from the event broker service 504. To identify the corresponding action, the inbox 508 may identify the action 510 corresponding to the event broker service 504. In certain implementations, the corresponding action may be identified based on the contents of the events. For example, the event broker service 504 and the event source 502 may correspond to two types of events: events for new users signing up to a mailing list and events for users unsubscribing from the mailing list. The action performed may correspond to the events for new users and a different action may correspond to users unsubscribing (e.g., based on a mapping or other request received when adding the event broker service 504 to the business object 506). Accordingly, to identify the corresponding event, the business object 506 may analyze the contents of the event (e.g., a “type” field of the event) to determine whether it corresponds to a new user sign up or a user unsubscribing. If the event corresponds to a new user sign up, the business object 506 may identify a first action as a corresponding action and, if the event corresponds to a user unsubscribing, the inbox 508 may identify a different action as the corresponding action. The action may then be performed based on the event. For example, the business object 506 and/or a computing device implementing the business object 506 may execute the action based on the event. For example, the action may include a workflow that is performed to create and send an email to the new user (e.g., a confirmation email). As a specific example, the event may include a name of the new user, an email address of the new user, and an email list for which the new user signed up. The action may be performed based on the event to generate an email to the email address contained within the event. The email may be generated based on the event to include an indication of the new user's name and an indication of the email list for which the user signed up. In particular, the business object 506 and/or its contents (e.g., contents updated based on the received event) may be provided to the workflow as a populated item reference. The workflow may execute based on the contents to generate and send the email.

In this way, the method 500 may enable the receiving and processing of events by business objects. Implementations such as this may extend the functionality of existing business objects to utilize events, enabling backwards compatibility with existing business object environments. Also, because business objects may be created and configured using visual programming interfaces, the method 500 may enable simplified setup and maintenance of event-based systems. Furthermore, because the events are received and processed directly by event broker services 504 within a business object environment, the events may be received and processed without requiring the event to be transformed into an intermediate data format. For example, the events may be transformed directly to properties that can be manipulated by the business objects and corresponding actions may be identified based on the event broker service 504 from which the events are received.

As depicted in FIG. 5A, messages are received and processed in a single transmission from the event source 502. It should be appreciated, however, that certain types of event sources may require more than one transmission to receive all of the information corresponding to an event. For example, pull event sources may require that new events be requested. As another example, authenticated push event sources may require multiple transmissions to verify the inbox 508 and/or event broker service 504 before transmitting an event (e.g., an event containing secure or confidential information). FIGS. 5B and 5C depict methods 540, 560 for receiving new events from such event sources. In particular, FIG. 5B depicts a method 540 of receiving new events from a pull event source and FIG. 5C depicts a method 560 of receiving new events from an authenticated push event source. Both methods 540, 560 use the same event source 502 and inbox 508. In particular, in certain implementations, the methods 540, 560 may be performed in combination with at least a portion of the method 500. For example, the methods 540, 560 may be performed instead of the blocks 520-524 of the method 500.

The method 520 may begin with the inbox 508 requesting an event (block 542). The inbox 508 may request the event by transmitting a request to the event source 502 (e.g., a pull event source). As explained further above, the inbox 508 may be configured to request new events from the event source 502 by polling the event source 502 at regular intervals (e.g., every 50 ms, every second, every 10 seconds, every hour, every day, every week). These intervals may change over time. For example, the inbox 508 may be configured to check for a new event every 1 minute during business hours and to check for a new event every one hour during other hours. The inbox 508 may also be configured to request new events in response to other triggers within a business object environment. For example, the inbox 508 may be configured to request new events in response to receiving a request from the business object 506.

The event source 502 may receive the request (block 544) and may transmit new events in response to the request (block 546). For example, the event source 502 may identify, based on the contents of the request, the inbox 508 and/or the event broker service 504 requesting the events. The event source 502, as explained above, may identify events that have not been received previously by the inbox 508 and/or the event broker service 504 and may transmit the new events that have not been received previously. Additionally or alternatively, the event source 502 may be configured to transmit all events for a preceding time period. For example, the event source 502 may transmit all events created within the last hour before the request was received from the inbox 508.

The inbox 508 may then receive the events (block 548). For example, the inbox 508 may receive the events in the event source for further processing. The inbox 508 may compare the events received from the event source 502 to other events previously received from the event source 502 (and/or other event sources) and may remove duplicate events that were previously received. The inbox 508 may then transmit events to the event broker service 504 (block 550). For example, the inbox 508 may transmit or otherwise provide the events to the event broker service 504 that are newly-received from the event source 502 (e.g., after removing duplicate events). The event may be further processed by the event broker service 504 (e.g., at block 526 of the method 500).

In this way, the method 540 enables the inbox 508 to interact with and receive events from pull event sources. In particular, the inbox 508 is configured to handle all correspondence with the event source 502 and to handle de-duplication of events received from the event source 502. In this way, events from pull event sources that are received and processed by other portions of the event broker service 504 are treated the same as events received from other types of event sources (e.g., push event sources). Such implementations accordingly reduce the complexity of event handling procedures for other portions of the system, such as business objects 506 configured to perform actions in response to received events. In particular, in practice, business objects may be presented with events received from pull event sources using the techniques of the method 540 in a manner similar or identical to events received from push event sources. Accordingly, the method 540 may the emulation or reproduction of functionality (i.e., automatic receipt of new events) of push event sources for pull event source requiring specific requests for new events.

The method 560 may begin with the event source 502 creating a new event notification (block 562). The new event notification may indicate that a new event has occurred and may identify the event, but may not contain substantive information regarding the particular occurrence that triggered the new event's creation. For example, in a file management system (e.g., a Sharepoint® system or the like), new events may be created when files are updated. In such instances, the new event notification may indicate that a file has been updated (e.g., within a directory for which the inbox 508 has subscribed to receive events). However, the new event notification may not indicate which file was updated.

The inbox 508 may receive the event notification (block 564). In response, the inbox 508 may transmit an authenticated callback (block 566). The authenticated callback may contain a token or other unique identifier (e.g., cryptographic identifier) of the inbox 508, the event broker service 504, and/or a user who connected the event source 502 to the business object environment.

The event source 502 may receive the authenticated callback (block 568). Upon receiving the authenticated callback, the event source 502 may verify whether the authenticated callback includes a valid token and/or a unique identifier of a valid user authorized to receive events (e.g., events regarding the file that was updated). The event source 502 may then transmit the new event (block 570). For example, upon verifying the authenticated callback, the event source 502 may transmit the new event to the inbox 508. The new event may include more specific information regarding the occurrence that triggered the event's creation and the new event notification. For example, the new event may identify a particular file that was updated and/or a directory containing the file that was updated. In additional or alternative implementations, the new event may indicate the contents or substance of the update to the file. The inbox 508 may then receive the new event (block 572) and may transmit the new event (block 574). For example, the inbox 508 may transmit the event to the event broker service 504. The event may then be further processed by the event broker service 504 (e.g., at block 526 of the method 500).

In this way, the method 516 enables the inbox 508 to receive and process events from event sources with more complex communication flows. In particular, the method 560 enables the inbox 508 to receive and process events from event sources that require authenticated callbacks, such as web events without payloads requiring authenticated callbacks. In this way, events from push event sources with callbacks, once received and processed by other portions of the event broker service 504, are treated the same as events received from other types of event sources (e.g., push event sources). Such implementations accordingly reduce the complexity of event handling procedures for other portions of the system, such as business objects 506 configured to perform actions in response to received events. Furthermore, methods similar to the method 560 may be performed to comply with other communication flows for other types of event sources requiring callbacks. For example, certain types of push event sources may require multiple authenticated callbacks. In such instances, the method 560 and/or the inbox 508 may be configured perform the necessary communication flows with the push event sources, extending the compatibility and functionality of subsequent event processing by the event broker service 504 and business objects 506 connected to the event broker service.

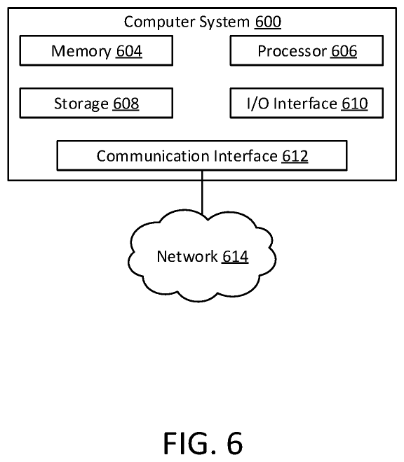

FIG. 6 illustrates an example computer system 600 that may be utilized to implement one or more of the devices and/or components discussed herein, such as the business objects 114, the visual programming interface 122, the data sources 102, the event broker services 206, 208, 210, and/or the event sources 202, 204. In particular embodiments, one or more computer systems 600 perform one or more steps of one or more methods described or illustrated herein. In particular embodiments, one or more computer systems 600 provide the functionalities described or illustrated herein. In particular embodiments, software running on one or more computer systems 600 performs one or more steps of one or more methods described or illustrated herein or provides the functionalities described or illustrated herein. Particular embodiments include one or more portions of one or more computer systems 600. Herein, a reference to a computer system may encompass a computing device, and vice versa, where appropriate. Moreover, a reference to a computer system may encompass one or more computer systems, where appropriate.

This disclosure contemplates any suitable number of computer systems 600. This disclosure contemplates the computer system 600 taking any suitable physical form. As example and not by way of limitation, the computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 606, memory 604, storage 608, an input/output (I/O) interface 610, and a communication interface 612. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 606 includes hardware for executing instructions, such as those making up a computer program. As an example and not by way of limitation, to execute instructions, the processor 606 may retrieve (or fetch) the instructions from an internal register, an internal cache, memory 604, or storage 608; decode and execute the instructions; and then write one or more results to an internal register, internal cache, memory 604, or storage 608. In particular embodiments, the processor 606 may include one or more internal caches for data, instructions, or addresses. This disclosure contemplates the processor 606 including any suitable number of any suitable internal caches, where appropriate. As an example and not by way of limitation, the processor 606 may include one or more instruction caches, one or more data caches, and one or more translation lookaside buffers (TLBs). Instructions in the instruction caches may be copies of instructions in memory 604 or storage 608, and the instruction caches may speed up retrieval of those instructions by the processor 606. Data in the data caches may be copies of data in memory 604 or storage 608 that are to be operated on by computer instructions; the results of previous instructions executed by the processor 606 that are accessible to subsequent instructions or for writing to memory 604 or storage 608; or any other suitable data. The data caches may speed up read or write operations by the processor 606. The TLBs may speed up virtual-address translation for the processor 606. In particular embodiments, processor 606 may include one or more internal registers for data, instructions, or addresses. This disclosure contemplates the processor 606 including any suitable number of any suitable internal registers, where appropriate. Where appropriate, the processor 606 may include one or more arithmetic logic units (ALUs), be a multi-core processor, or include one or more processors 606. Although this disclosure describes and illustrates a particular processor, this disclosure contemplates any suitable processor.

In particular embodiments, the memory 604 includes main memory for storing instructions for the processor 606 to execute or data for processor 606 to operate on. As an example, and not by way of limitation, computer system 600 may load instructions from storage 608 or another source (such as another computer system 600) to the memory 604. The processor 606 may then load the instructions from the memory 604 to an internal register or internal cache. To execute the instructions, the processor 606 may retrieve the instructions from the internal register or internal cache and decode them. During or after execution of the instructions, the processor 606 may write one or more results (which may be intermediate or final results) to the internal register or internal cache. The processor 606 may then write one or more of those results to the memory 604. In particular embodiments, the processor 606 executes only instructions in one or more internal registers or internal caches or in memory 604 (as opposed to storage 608 or elsewhere) and operates only on data in one or more internal registers or internal caches or in memory 604 (as opposed to storage 608 or elsewhere). One or more memory buses (which may each include an address bus and a data bus) may couple the processor 606 to the memory 604. The bus may include one or more memory buses, as described in further detail below. In particular embodiments, one or more memory management units (MMUs) reside between the processor 606 and memory 604 and facilitate accesses to the memory 604 requested by the processor 606. In particular embodiments, the memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory implementations, this disclosure contemplates any suitable memory implementation.

In particular embodiments, the storage 608 includes mass storage for data or instructions. As an example and not by way of limitation, the storage 608 may include a hard disk drive (HDD), a floppy disk drive, flash memory, an optical disc, a magneto-optical disc, magnetic tape, or a Universal Serial Bus (USB) drive or a combination of two or more of these. The storage 608 may include removable or non-removable (or fixed) media, where appropriate. The storage 608 may be internal or external to computer system 600, where appropriate. In particular embodiments, the storage 608 is non-volatile, solid-state memory. In particular embodiments, the storage 608 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 608 taking any suitable physical form. The storage 608 may include one or more storage control units facilitating communication between processor 606 and storage 608, where appropriate. Where appropriate, the storage 608 may include one or more storages 608. Although this disclosure describes and illustrates particular storage, this disclosure contemplates any suitable storage.

In particular embodiments, the I/O Interface 610 includes hardware, software, or both, providing one or more interfaces for communication between computer system 600 and one or more I/O devices. The computer system 600 may include one or more of these I/O devices, where appropriate. One or more of these I/O devices may enable communication between a person (i.e., a user) and computer system 600. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 610 may include one or more device or software drivers enabling processor 606 to drive one or more of these I/O devices. The I/O interface 610 may include one or more I/O interfaces 610, where appropriate. Although this disclosure describes and illustrates a particular I/O interface, this disclosure contemplates any suitable I/O interface or combination of I/O interfaces.

In particular embodiments, communication interface 612 includes hardware, software, or both providing one or more interfaces for communication (such as, for example, packet-based communication) between computer system 600 and one or more other computer systems 600 or one or more networks 614. As an example and not by way of limitation, communication interface 612 may include a network interface controller (NIC) or network adapter for communicating with an Ethernet or any other wire-based network or a wireless NIC (WNIC) or wireless adapter for communicating with a wireless network, such as a W-Fi network. This disclosure contemplates any suitable network 614 and any suitable communication interface 612 for the network 614. As an example and not by way of limitation, the network 614 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 600 may include any suitable communication interface 612 for any of these networks, where appropriate. Communication interface 612 may include one or more communication interfaces 612, where appropriate. Although this disclosure describes and illustrates a particular communication interface implementations, this disclosure contemplates any suitable communication interface implementation.

The computer system 602 may also include a bus. The bus may include hardware, software, or both and may communicatively couple the components of the computer system 600 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
adding a new event source to a business object environment;
creating, based on the new event source, a broker service that includes one or more required business object contents for receiving and processing events from the new event source;
receiving a request to add the new event source to a business object of the business object environment, the request specifying a mapping between an event received from the new event source and performing a particular action by the business object; and
adding the broker service to the business object by:
linking the business object to the new event source; and
linking events received from the new event source to at least one action of the business object to perform the particular action.

2. The method of claim 1, further comprising receiving and processing events from the new event source with the business object.

3. The method of claim 2, wherein the business object is further configured to receive and process at least one of (i) events from an additional event source in addition to the new event source and (ii) data from a data source.

4. The method of claim 1, wherein adding the one or more required business object contents to the business object further comprises determining that at least one of the required business object contents are not included within the business object.

5. The method of claim 1, wherein the mapping is a direct mapping between receiving an event from the event broker service and performing the particular action by the business object, and wherein the event from the event broker service is directly linked to the at least a first subset of the required business object contents with no intervening data structures.

6. The method of claim 1, wherein creating the broker service includes adding an inbox to the business object environment, wherein the inbox is subscribed to the new event source.

7. The method of claim 6, wherein the new event source is a pull event source and the inbox is configured to periodically request events from the pull event source and, upon receiving events, to exclude duplicate events from further processing.

8. The method of claim 6, wherein the new event source is a push event source that requires an authenticated callback, and the inbox is configured, in response to receiving a new event notification from the push event source, to transmit an authenticated callback to the push event source according to a communication protocol of the push event source.

9. The method of claim 1, wherein linking the new event source includes linking the broker service to the business object.

10. The method of claim 1, wherein the required business object contents include at least one of business object methods, business object properties, business object inboxes, and additional event sources.

11. The method of claim 1, further comprising storing an indication of the new event source in association with the broker service for use in adding the new event source to additional business objects.

12. The method of claim 11, wherein the broker service includes the indication of the new event source.

13. The method of claim 1, further comprising, prior to adding the new event source to the business object environment, receiving a request to register the new event source.

14. The method of claim 13, wherein the request is received from a user via a graphical user interface including a visual programming interface.

15. The method of claim 14, wherein the broker service is configured using the visual programming interface.

16. The method of claim 13, wherein the request includes a declarative description of the new event source.

17. A system comprising:
a processor; and
a memory storing instructions which, when executed by the processor, cause the processor to:
add a new event source to a business object environment;
create, based on the new event source, a broker service that includes one or more required business object contents for receiving and processing events from the new event source;
receive a request to add the new event source to a business object of the business object environment, the request specifying a mapping between an event received from the new event source and performing a particular action by the business object; and
add the broker service to the business object by:
linking the business object to the new event source; and
linking events received from the new event source to at least one action of the business object to perform the particular action.

18. The system of claim 17, wherein the mapping is a direct mapping between receiving an event from the event broker service and performing the particular action by the business object, and wherein the event from the event broker service is directly linked to the at least a first subset of the required business object contents with no intervening data structures.

19. The system of claim 17, wherein creating the broker service includes adding an inbox to the business object environment, wherein the inbox is subscribed to the new event source.

20. A non-transitory, computer-readable medium storing instructions which, when executed by a processor, cause the processor to:
add a new event source to a business object environment;
create, based on the new event source, a broker service that includes one or more required business object contents for receiving and processing events from the new event source;
receive a request to add the new event source to a business object of the business object environment, the request specifying a mapping between an event received from the new event source and performing a particular action by the business object; and
add the broker service to the business object by:
linking the business object to the new event source; and
linking events received from the new event source to at least one action of the business object to perform the particular action.
